(19) United States
(12) Patent Application Publication
(10) Pub. No.: US 2025/0270127 A1
(43) Pub. Date: Aug. 28, 2025

(54) System and Method for Recovering Waste Energy at Treatment Plants

(71) Applicant: Robert Fiorile, Ponce Inlet, FL (US)

(72) Inventor: Robert Fiorile, Ponce Inlet, FL (US)

(21) Appl. No.: 18/585,395

(22) Filed: Feb. 23, 2024

(51) Int. Cl. C02F 9/00; C02F 1/00; C02F 1/50; C02F 3/02; H01M 10/44; H01M 50/204; H01M 50/251; H02K 7/18

(52) U.S. Cl. CPC C02F 9/00; H01M 10/441; H01M 50/204; H01M 50/251; H02K 7/1823; C02F 1/006; C02F 2001/007; C02F 1/50; C02F 3/02; C02F 2303/04; C02F 2303/10; H01M 2220/10

(57) ABSTRACT

A novel system and method designed to enhance energy recovery at wastewater treatment facilities by harnessing waste energy from water flow between treatment ponds. The invention incorporates an innovative arrangement of turbines strategically placed within the effluent streams to generate electricity, supplemented by generators in the effluent launders for optimized energy capture. This generated energy is then efficiently stored in batteries or can be fed back into the power grid. The system's modular design allows for the addition of multiple turbines and generators, adapting to varying energy recovery needs. Further integration with renewable energy sources, such as wind turbines and solar panels, situated on the treatment plant's premises, creates a comprehensive energy recovery and augmentation solution. This approach not only improves the energy efficiency of wastewater treatment plants but also contributes to a reduction in operational costs and environmental impact.

### RELATED APPLICATIONS

This application claims priority to U.S. Provisional Patent Application No. 63/447,664, filed on 23 Feb. 2023, which is incorporated herein by reference in its entirety, including any addendums, appendixes, and attachments thereto, to the extent these applications do not conflict with the present disclosure herein.

### FIELD OF INVENTION

This invention relates to a system and method for recovering waste energy at waste water treatment plants.

### BACKGROUND

The following discussion is not to be deemed admitted prior art but merely related art to show possible background and information related to recovering waste energy at treatment plants.

Over 16,000 wastewater treatment plants in the United States operate, handling millions of gallons of water daily.¹ These facilities primarily rely on gravity for fluid movement, supplemented by pumps in situations where gravity assistance is insufficient. ¹ 2021 Report Card for America's Infrastructure, https://infrastructurereportcard.org/cat-item/wastewater-infrastructure/ (last visited Jan. 20, 2023).

Given their outdoor locations, often in areas exposed to significant wind and sunlight, these facilities present untapped potential for leveraging natural resources for energy recovery. Despite the critical need to optimize energy use and reduce operational costs, this potential remains largely unexploited.

Considering the gravity flow of fluids, wind, and sun, there is an opportunity to recover energy and use the recovered energy in the facility. Excess energy can be stored locally onsite in batteries or pushed back to an external power grid.

While current practices include using external power sources, such as the local power grid, these methods are fraught with challenges, including high costs and susceptibility to disruptions from weather events, infrastructure failures, or security breaches.

The limitations of existing solutions underscore the pressing need for innovative approaches to energy recovery in wastewater treatment facilities. An efficient, reliable system that harnesses gravity, wind, and solar energy could significantly mitigate these issues, reducing reliance on external power sources and enhancing operational sustainability.

Therefore, a need exists for a novel system and method for recovering waste energy at treatment plants.

### BRIEF SUMMARY OF THE INVENTION

This invention relates generally to, but is not limited to, recovering energy at treatment plants from treatment plant streams.

Disclosed are numerous aspects of a unique system and method for recovering waste energy at treatment plants.

It is desirable to have a system and method to recovery potential energy losses at a treatment plant that can be used safely. Furthermore, it is desirable to have a system and method for recovering waste energy at treatment plants that can be used with new facilities or retrofitted to existing facilities. Furthermore, it is desirable that a system and method for recovering waste energy at treatment plants be self-contained. Furthermore, it is desirable that a system and method for recovering waste energy at treatment plants is capable of storing excess energy collected.

The disclosed invention advantageously fills these needs and addresses the aforementioned deficiencies by providing an easy to use, safe, easily installed, system and method for recovering energy at treatment plants.

### BRIEF DESCRIPTION OF THE DRAWINGS

A system and method for recovering waste energy at treatment plants is illustrated by way of example, and not by way of limitation, in the figures of the accompanying drawings.

While aspects of a system and method for recovering waste energy at treatment plants will be described with reference to the details of the embodiments of the invention shown in the drawings (and some embodiments not shown in the drawings), these details are not intended to limit the scope of the invention.

FIG. 1. An example overview block diagram for a typical wastewater treatment plant where an example embodiment system and method for recovering waste energy at treatment plants may be implemented.

FIG. 2. An example overview block diagram for different, typical wastewater treatment plant where an example embodiment system and method for recovering waste energy at treatment plants may be implemented.

FIG. 3. An example overview block diagram for a typical water treatment plant where an example embodiment system and method for recovering waste energy at treatment plants may be implemented.

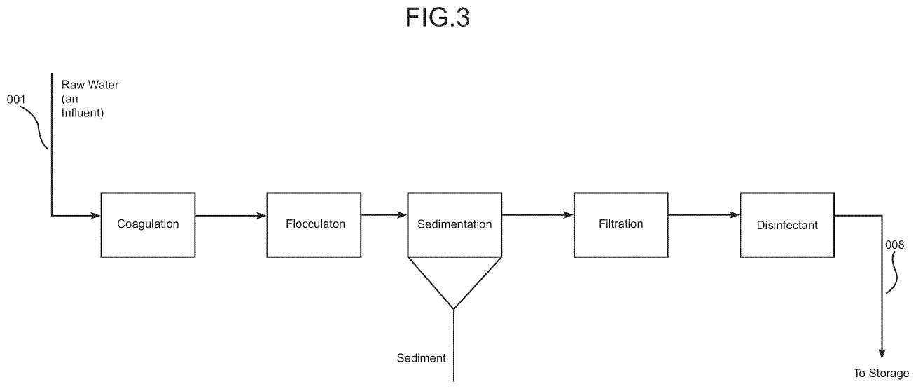

FIG. 4. An example overview block diagram for one example embodiment system and method for recovering waste energy at treatment plants.

FIG. 5. A perspective view of an embodiment of a system and method for recovering waste energy at treatment plants showing a transport stream with a liquid turbine-generator in a transport stream.

FIG. 6. A side view of an embodiment of a system and method for recovering waste energy at treatment plants showing a transport stream with a liquid turbine-generator in a transport stream.

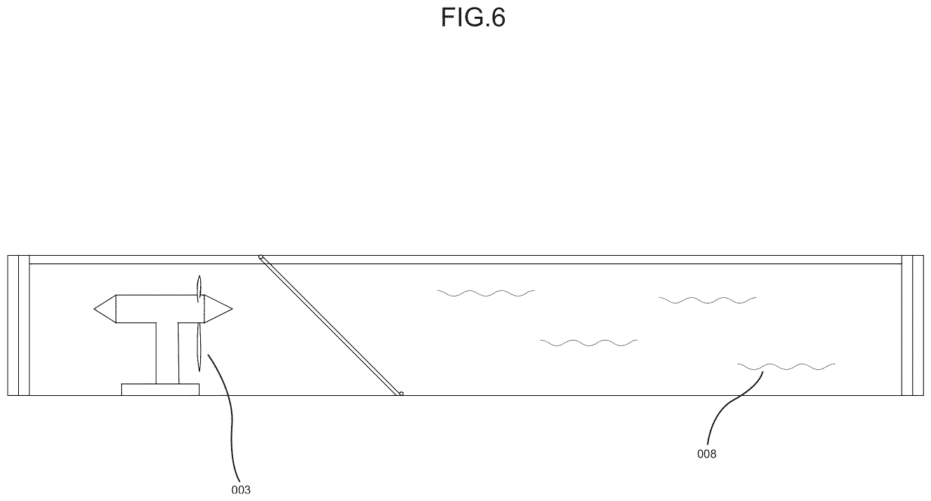

FIG. 7. A top-down view of an embodiment of a system and method for recovering waste energy at treatment plants showing a transport stream with a liquid turbine-generator in a transport stream.

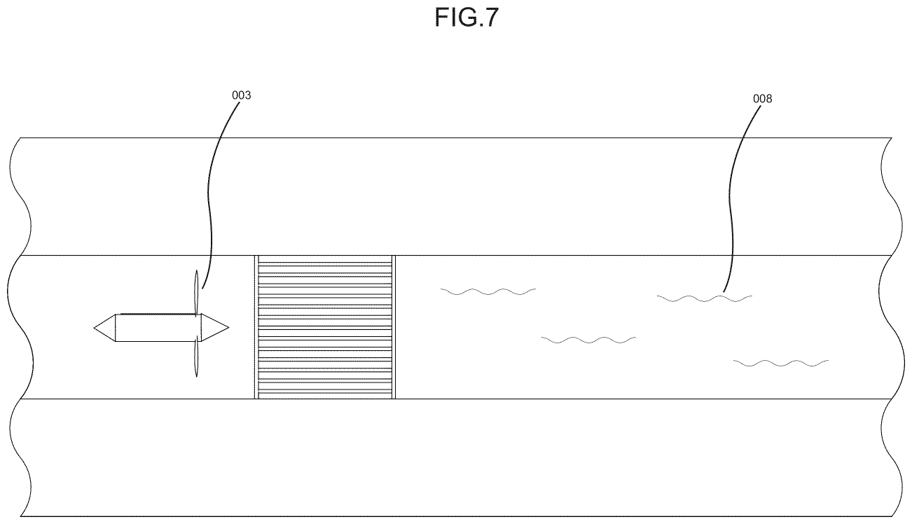

FIG. 8. An example overview block diagram of a sample embodiment of a system and method for recovering waste energy at treatment plants.

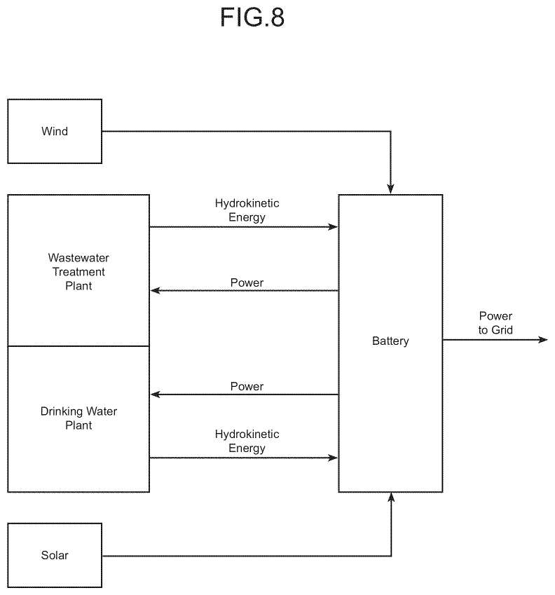

FIG. 9. A perspective view of an embodiment of a system and method for recovering waste energy at treatment plants showing a clarifier with liquid turbine-generators in the overflow weir.

FIG. 10. A top-down view of an embodiment of a system and method for recovering waste energy at treatment plants showing a clarifier with liquid turbine-generators in the overflow weir.

### LIST OF FIGURE ITEMS

000 A system and method for recovering waste energy at Treatment Plants
001 An influent stream
002 An effluent stream
003 A turbine
004 A battery
005 A solar panel
006 A wind turbine
007 A treatment pond
008 A transport stream
009 A clarifier
010 A generator
011 An aeration tank
012 A disinfectant tank
013 A filtration process

### DETAILED DESCRIPTION

The order of the steps of disclosed processes may be altered within the scope of

the invention.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. A system and method for recovering waste energy at treatment plants may, however, be embodied in many different forms and should not be construed as being limited to the embodiments set forth herein; rather, these embodiments are provided by way of illustration only and so that this disclosure will be thorough, complete and fully convey understanding to those skilled in the art.

For the purposes of promoting an understanding of the principles of a system and method for recovering waste energy at treatment plants, reference will now be made to the embodiments illustrated in the drawings and specific language will be used to describe the same, only as examples and not intended to be limiting.

Treatment plants as used herein may be, but are not limited to, wastewater treatment plants, water reclamation treatment plants, freshwater treatment facilities, storm-water treatment plants, chemical effluent treatment facilities. Additional treatment plant types applicable to this invention include industrial wastewater, agricultural wastewater, greywater recycling systems, leachate, oil and gas wastewater, thermal power plants, food and beverage wastewater, and pulp and paper mill wastewater.

In the context of this invention, transport streams facilitate the movement of liquids between ponds and may encompass a variety of structures, including but not limited to, piping and concrete channels. For illustrative purposes and without limiting the invention's scope, a concrete channel may vary in width from approximately 0.5 meters (about 1.64 feet) to 5 meters (approximately 16.4 feet) and in depth from 0.5 meters (roughly 1.64 feet) to 2 meters (near 6.56 feet). These transport streams are designed with a gradient to enhance the liquid flow between ponds, optimizing the efficiency of the transportation process.

As liquids move through the transport streams energy is available from this flow for recovery.

Liquids move through typical treatment plants used by municipalities at a flow rate of, not meant to be limiting, 11,000 to 750,000 cubic meters (approximately 3,000,000 to 200,000,000 gallons) per day.

Clarifiers, as described herein, are tanks equipped with a specialized mechanism for the continuous removal of solids through sedimentation, concurrently facilitating water filtration. These systems typically include an inlet stream for wastewater entry, scum removal equipment to extract floating solids, an overflow weir to maintain water levels, an effluent launder for directing clarified water, and an effluent stream for the discharge of treated water. For illustrative purposes, and without limiting the scope of potential embodiments, clarifiers may range in diameter from 24 meters (approximately 80 feet) to 92 meters (about 300 feet), accommodating various operational scales and capacities.

As liquid moves through the clarifier energy is available from this flow for recovery.

The weir overflow rate (WOR) is the volume of wastewater that flows over one linear meter of weir per day. The typical WOR range for primary clarifiers is approximately 3,785 to 7,570 liters per day per linear meter of weir. Alternatively, the weir overflow rate (WOR) is the number of gallons of wastewater that flow over one lineal foot of weir per day. The typical WOR range for primary clarifiers is 10,000 to 20,000 gallons per day per lineal foot of weir.

The calculation for the weir overflow is:

Weir Overflow (GPD/ft)=[Flow Rate GPD]/[Length of Weir ft]

The present invention introduces a comprehensive system and method designed to optimize waste energy recovery at treatment plants. This system encompasses an integrated arrangement of components, including: (1) an influent stream 001 for introducing wastewater into the system; (2) a series of primary sedimentation tanks 007 for initial solid removal; (3) aeration tanks 011 for biological treatment; (4) clarifier tanks 009 for further sedimentation; (5) a flow diversion stream to manage the flow between processes; (6) disinfection tanks 012 for pathogen removal before discharge; and (7) effluent streams 002 for the treated water output. Key to the energy recovery process are (8) transport streams 008 that connect the sedimentation, aeration, clarifier, and disinfection tanks, facilitating efficient fluid movement; (9) batteries 004 for storing the recovered energy; (10) liquid turbines 003 strategically placed within the transport streams 008 to harness kinetic energy; and (11) generators 010 for converting the turbine-generated energy into electricity. This system leverages the inherent energy potential within the treatment process, enhancing sustainability and operational efficiency.

Disclosed is a system and method for recovering waste energy at treatment plants, comprising the following components: (1) an influent stream 001, a plurality of primary sedimentation tanks, a plurality of aeration tanks, a plurality of clarifier tanks, a flow diversion stream, a plurality of disinfection tanks, and a plurality of effluent streams 002; (2) wherein the sedimentation tanks, aeration tanks, clarifier tanks 009, disinfection tanks are connected by transport streams 008; (3) one or more batteries 004, (4) one or more liquid turbines 003, (5) one or more generators 010.

In the disclosed energy recovery system for treatment plants, the configuration operates as follows: A turbine-generator 003,010, strategically inserted within a transport stream 008, harnesses kinetic energy as liquid passes through, generating electricity. This electricity is then conveyed through conductive wires to a storage battery 004, ensuring efficient energy capture. Similarly, a turbine-generator 003,010 is innovatively positioned within an effluent launder of a clarifier, utilizing liquid flow to produce additional electrical energy. This energy is likewise directed to the battery 004 for storage. Stored energy is subsequently utilized within the facility, showcasing the system's capability to significantly enhance operational efficiency and sustainability.

These components generally speaking, are configured as follows: (1) a turbine 003 is inserted in a transport stream 008 (2) liquid flows through the turbine 003 creating energy; (3) energy collected from the turbine-generator 003,010 is transported via wires to a battery 004 (4) a turbine-generator 003,010 is placed in a effluent launder in a clarifier; (5) liquid flows through the turbine-generator 003,010 creating energy; (6) energy collected from the turbine-generator 003,010 is transported via wires to a battery 004; (7) energy is stored and later used at the facility.

Some embodiments of a system and method for recovering waste energy at treatment plants may have a plurality of turbine-generators 003,010 placed in the clarifier effluent launder.

A system and method for recovering waste energy at treatment plants may also have one or more of the following: a plurality of batteries, a plurality of turbines, a plurality of generators, a plurality of solar panels, a plurality of wind turbines, charge controllers, power conditioning equipment, safety equipment, meters and instrumentation.

The disclosed system and method for recovering waste energy at treatment plants is unique when compared with other known devices and solutions because it provides: (1) for operation without interfering the transport streams at the treatment plant; (2) may be retrofitted to an existing plant; (3) reduces energy consumption from outside sources and therefore reduces the carbon footprint of the facility.

The disclosed system and method for recovering waste energy at treatment plants is unique in that it is structurally different from other known devices or solutions. More specifically, the device is unique due to the presence of (1) a turbine of a size that can be used in various transport streams; (2) supports multiple turbines; (3) a generator of a size that can be used in various clarifiers; (4) a generator of a size and shape that can be fit to clarifier effluent launders of different sizes; (5) batteries that can vary in size and adapt to different levels of energy consumption.

In some embodiments of versions of a system and method for recovering waste energy at treatment plants a battery 004 may vary in size, for example, and not meant to be limiting, having a capacity of 100 Ah to 3200 Ah and be used in series or parallel for maximum storage and output.

A battery 004 like those made by Redflow, using the ZBM3 battery zinc-bromine flow battery is an example of an embodiment, not meant to be limiting.

In some embodiments of versions of a system and method for recovering waste energy at treatment plants a turbine 003 is of a size, not meant to be limiting, the tube diameter may range from 0.1 meters to 3 meters, and have an output range of capacity of 5 kW to 35 kW.

In some embodiments of versions of a system and method for recovering waste energy at Treatment Plants there may be one influent stream 001 or a plurality of influent streams 001.

In some embodiments of versions of a system and method for recovering waste energy at treatment plants there may be a plurality of transport streams 008 between various steps of the treatment process.

Calculations for the method of recovering waste energy, by example, are as follows. For instance, a particular wastewater treatment plant has six (6) waterfalls wherein one is 2.4 meters (8 feet) high and the other five waterfalls are 0.9 meters (3 feet) high. The potential energy from a waterfall is:

Potential Energy (PE)=mgh

where m is the mass in kilograms

g is the acceleration due to gravity (9.81 m/s²)

h is the height in meters

In the sample embodiment 5,000,000 gallons pass through the 8 foot waterfall and 2,500,000 gallons pass through the 3 foot waterfalls.

Sample calculation method for the waterfalls:

Convert the Water Flow from gallons to cubic meters to find the volume, since 1cubic meter of water has a mass of 1,000 kg. The conversion factor from gallons to cubic meters is 1 gallon-0.00378541 cubic meters.

Convert the Height of the waterfall from feet to meters to use in the formula. The conversion factor is 1 foot=0.3048 meters.

Calculate the Mass of the water flowing per day using the volume, with the knowledge that 1 cubic meter of water has a mass of approximately 1,000 kg.

Calculate the Potential Energy using the formula, converting the final energy from Joules to kilowatt-hours (kWh) for a daily output, since 1 kWh=3.6×10⁶ Joules.

For the 8-foot waterfall at 5,000,000 gallons per day the calculations would be: (5,000,000*0.00378541 cubic meters/gallon) (1,000 kg/cubic meter)=>18,927,050 kg per day.

(18927050)*9.81*(8 feet*0.3048 meters/foot)=452,748,360.6 kg-m²/s² 452,748,360.6 Joules*1 kWh/3.6 million Joules=125.76 kWh

For the 5-foot waterfalls at 2,500,000 gallons per day the calculations would be: (2,500,000*0.00378541 cubic meters/gallon) (1,000 kg/cubic meter)=>9,463,525 kg per day.

(9463525)*9.81*(3 feet*0.3048 meters/foot)=84,890,317.6 kg-m²/s² 84,890,317.6 Joules*1 kWh/3.6 million Joules=23.6 kWh per waterfall 5*23.6 kWh=118 kWh

The total energy available is 243.7 kWh of the six waterfalls with a flow of 5 mm GPD.

In an alternative embodiment operating at a larger scale, increasing the flow rate by a factor of 10 increases the available energy.

A turbine in the stream will typically operate at 65% to 75% efficiency.

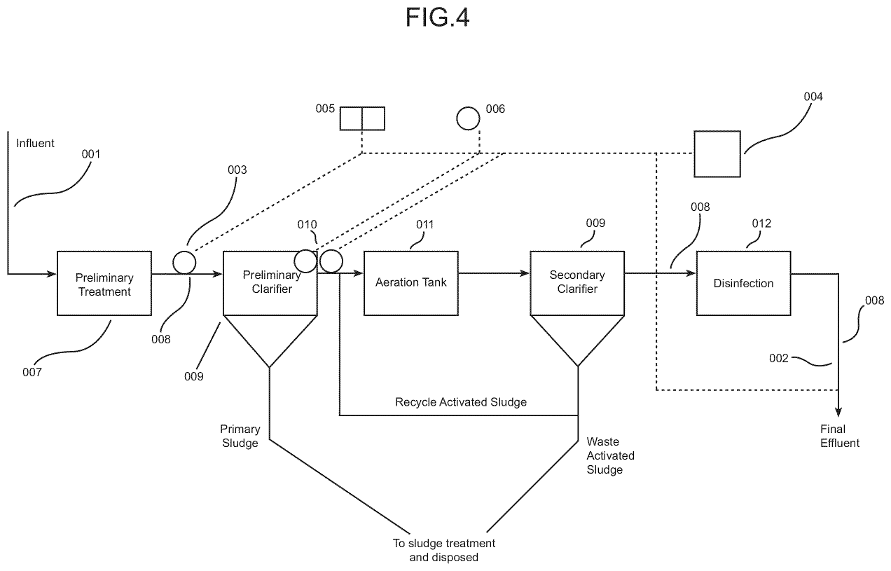

In some embodiments of versions of a system and method for recovering waste energy at treatment plants as shown in FIG. 4 a sample wastewater treatment facility. An influent stream 001 flows to preliminary treatment 007 pond. A transport stream 008 flows to a 260 preliminary clarifier; a plurality of water turbines 003 are placed in a transport stream 008 and recovered energy is transported via wires to battery 004. A plurality of generators 010 are placed in a clarifier and recovered energy is transported to a battery 004. At some facilities a plurality of solar panels 005 are connected to a battery 004. At some facilities a plurality if wind turbines 006 are connected to a battery 004.

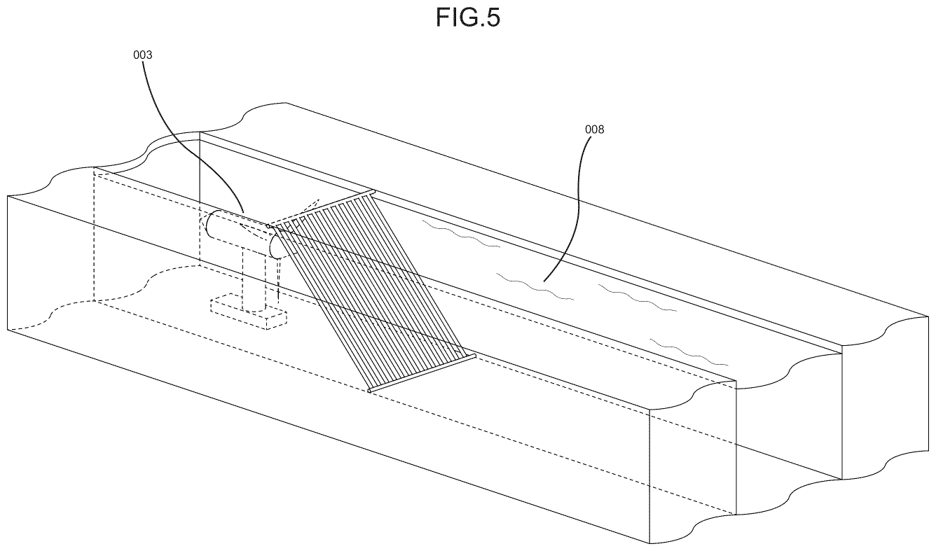

In some embodiments of versions of a system and method for recovering waste energy at treatment plants as shown in FIG. 5,6,7 a liquid turbine-generator 003, 010 is placed in a transport stream 008. The liquid level in a transport stream will be higher than the diameter of the liquid turbine-generator 003, 010. This is a novel approach to capturing the flow in the transport stream 008 for energy recovery. Placement of the turbine-generator may be horizontal or vertical and multiple turbine-generators may be used based on the overall fluid flow rate and configuration of the transport stream.

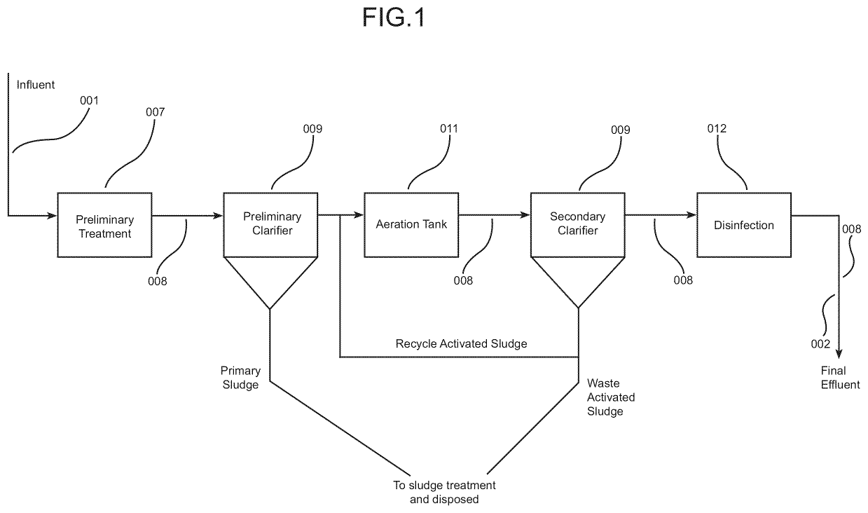

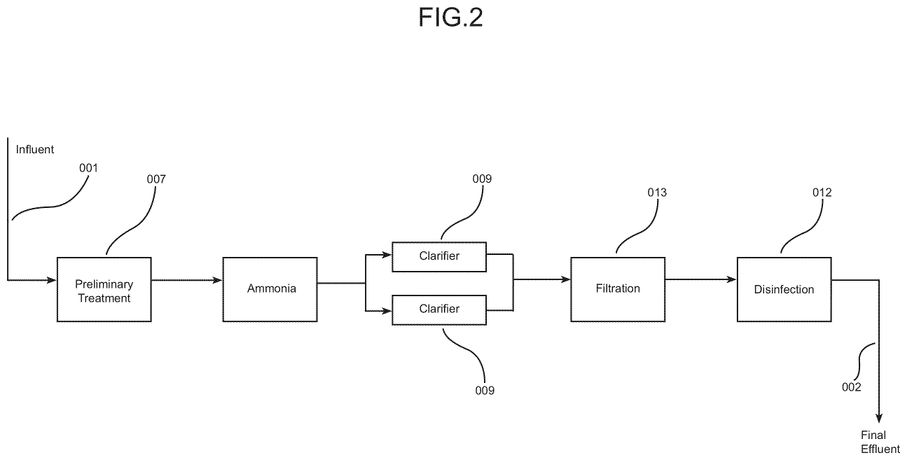

A system and method for recovering waste energy at treatment plants block diagram is shown in FIGS. 1, 2, and 4 show a typical wastewater treatment plant. Treatment components are connected via transport streams 009. A liquid turbine-generator 003 is placed in the transport streams as show in the Figures.

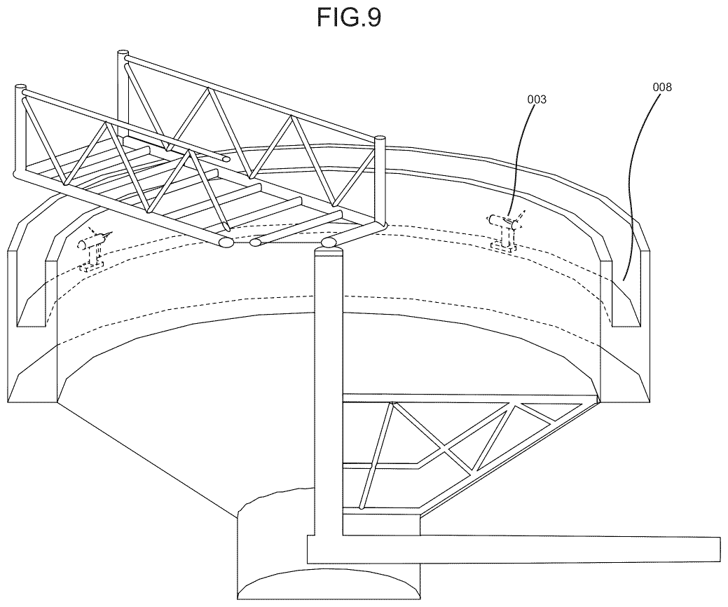

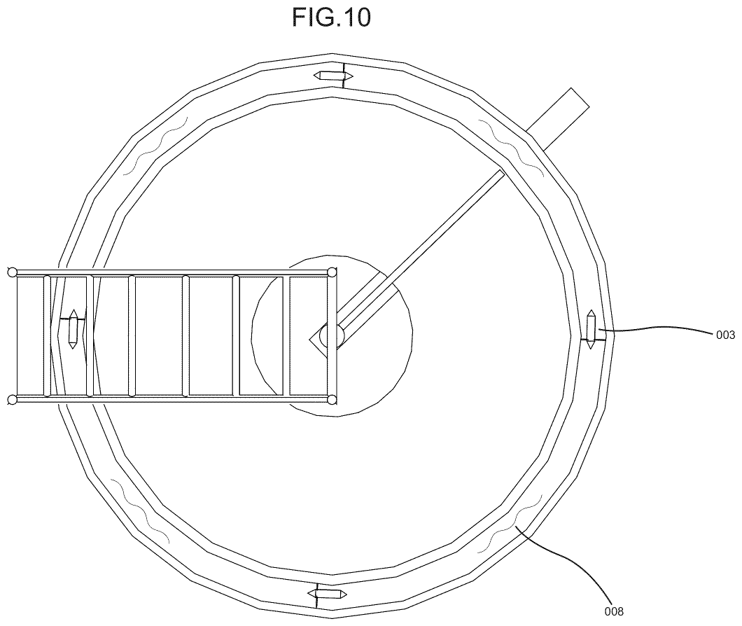

A possible embodiment of a system and method for recovering waste energy at treatment plants is shown in FIGS. 9 and 10. In the figures, liquid turbine-generators 003, are placed in the clarifier effluent launder. These liquid-turbine generators are connected to the charge controller and battery storage system for energy recovery.

A version of the invention may be a method of adapting a treatment plant with a system and method for recovering waste energy at treatment plants, comprising: selecting a hypothetical treatment plant 000 a battery 004 a liquid turbine-generator 003, 010 placing said liquid turbine-generator 003, 010 in said transport stream 008 and connecting said liquid turbine-generator 003, 010 to said battery 004; capturing the energy from said liquid turbine 003 in said battery 004 and storing the energy for use at the treatment plant or returning the energy off-site.

A typical liquid turbine-generator 003, 010 will be of a size to fit in a transport stream 008. One skilled in the art will know to find the correctly sized liquid turbine-generator 003, 010, mount the liquid turbine-generator 003, 010 to the transport stream 008 in a way that the liquid turbine-generator 003, 010 will remain stationary, and run wiring from the liquid turbine-generator 003, 010 to an energy charge controller for storage in the battery 004 or to return to the power grid.

Versions of a system and method for recovering waste energy at treatment plants may be made individually, in batches, or via continuous assembly.

For example, to make an embodiment of a version of a system and method for recovering waste energy at treatment plants assemble all of the components disclosed herein. Assemble the components in a logical order as someone skilled in the art would do. For example, start with a liquid turbine-generator 003, 010 a battery 004 and wires to connect to the liquid turbine-generator 003, 010 and battery 004; additional items like charge controllers, switches, and other accessories to safely manage the power connection and management. Place the liquid turbine-generator 003, 010 in a transport stream 008 at a treatment facility, checking flow in the transport stream 008 before and after, measure power output from the liquid turbine-generator 003, 010 to ensure it is correctly installed. Connect the liquid turbine-generator 003, 010 to a charge controller and battery 004 to capture and store energy.

An example embodiment of the application of the system and method for recovering energy at a treatment plant would begin with bringing a fluid into a treatment process using a starting flow or path like an influent stream. The fluid moves through different parts of the treatment process using gravity where the starting point of the process is typically at a higher elevation than the ending point. These parts are linked by channels or pipes that help move the fluid smoothly and efficiently. In these channels, devices called liquid turbine-generators are installed. As the fluid moves, it makes these devices spin, turning the movement of the fluid into useful energy. Additionally, a system with a charge controller and batteries properly sized for the overall system is installed. Conductive wires connect the liquid turbine-generators, charge controller, and batteries. The energy collected with the turbine-generators is then moved to the batteries and stored for later use. The stored energy is used to power parts in the treatment plant itself. If more energy is stored than needed the excess can be transported to the main power grid for others to use.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

The embodiments of a system and method for recovering waste energy at Treatment Plants may be utilized individually, concurrently, or in any sequential combination.

Those skilled in the art to which this application relates will appreciate that other and further additions, deletions, substitutions and modifications may be made to the described embodiments.

The specification is not to be taken in a limiting sense, but is made merely for the purpose of describing the general principles of exemplary embodiments; many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The invention is described with such embodiments, but the invention is not limited to any embodiment. The scope of the invention is limited only by the claims and the invention encompasses numerous alternatives, modifications and equivalents. Several specific details are set forth in the description to provide a thorough understanding of the invention. These details are provided for the purpose of example and the invention may be practiced according to the claims without some or all of these specific details. In general, the order of the steps of disclosed processes may be altered within the scope of the invention.

Unless otherwise indicated, the drawings are intended to be read (e.g., arrangement of parts, proportion, degree, etc.) together with the specifications, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein.

Further, the described features, structures, or characteristics of the present disclosure may be combined in any suitable manner in one or more embodiments. In the Detailed

Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

What is claimed is:

1. A system for recovering waste energy at treatment plants, comprising:
an influent stream configured to introduce fluid into a treatment plant;
wherein the treatment plant further comprising a plurality of sedimentation tanks for initial solids removal;
a plurality of aeration tanks for biological treatment;
a plurality of clarifier tanks with effluent launders;
a flow diversion stream to manage the flow between processes;
a plurality of disinfection tanks for pathogen removal before discharge;
a plurality of effluent streams for a treated fluid output;
a plurality of transport streams that connect the sedimentation tanks, aeration tanks, clarifier tanks, and disinfection tanks, facilitating efficient fluid movement;
a plurality of liquid turbine-generators placed within the transport streams to harness kinetic energy;
a charge controller system to manage the flow of energy;
a plurality of batteries for storing recovered energy;
a plurality of conductive wires; and
wherein the conductive wires connect the liquid turbine-generators to the charge controller system and the batteries.

2. The system of claim 1, wherein the liquid turbine-generators are strategically inserted within a transport stream to maximize kinetic energy recovery from liquid flow.

3. The system of claim 1, further comprising one or more micro liquid turbine-generators positioned within an effluent launder of a clarifier, configured to utilize liquid flow to generate additional electrical energy.

4. The system of claim 1, wherein the energy collected from the liquid turbine-generators is transported via conductive wires to the batteries for storage.

5. The system of claim 1, further configured to utilize stored energy within the treatment plant or send excess energy to an external power grid.

6. A method for recovering waste energy at treatment plants, the method comprising:
introducing a fluid into a system for recovering waste energy at treatment plants via an influent stream;
passing the fluid through a plurality of treatment components;
wherein the treatment components further comprising a plurality of sedimentation tanks for initial solids removal; a plurality of aeration tanks for biological treatment; a plurality of clarifier tanks with effluent launders; a flow diversion stream to manage the flow between processes; a plurality of disinfection tanks for pathogen removal before discharge; a plurality of effluent streams for a treated fluid output; a plurality of transport streams that connect the sedimentation tanks, aeration tanks, clarifier tanks, and disinfection tanks, facilitating efficient fluid movement;
connecting the treatment components via transport streams to facilitate efficient fluid movement;
placing one or more liquid turbine-generators within the transport streams to harness kinetic energy from the fluid movement;
installing a properly sized charge controller system and batteries to store collected energy;
transporting energy collected from turbine-generators to batteries for storage; and
utilizing stored energy within the treatment plant or returning excess energy to an external power grid.

7. The method of claim 6, wherein the placing of liquid turbine-generators is optimized based on a flow characteristic of the transport streams and clarifiers, respectively, to maximize energy recovery.

8. The method of claim 6, wherein an existing treatment plant is retrofitted to recover waste energy, comprising:
assessing a layout and a plurality of flow characteristics of an existing treatment plant;
selecting optimal locations for the placing of a plurality of liquid turbine-generators within transport streams and effluent launders;
installing the selected liquid turbine-generators;
connecting the liquid turbine-generators to batteries using conductive wires; and
configuring the system to store recovered energy or send excess energy to an external power grid.
